(19) United States
(12) Patent Application Publication
(10) Pub. No.: US 2010/0174747 A1
(43) Pub. Date: Jul. 8, 2010

(54) METHODS FOR RECOMMENDING NEW INDIVIDUALS TO BE INVITED INTO A CONFIRMED SOCIAL NETWORK BASED ON MINED SOCIAL DATA

(75) Inventors: Stephen P. Farrell, San Francisco, CA (US); Ido Guy, Haifa (IL); Inbal Ronen, Haifa (IL); Sigalit Ur, Misgav (DE); Eric Wilcox, Los Altos, CA (US)

Correspondence Address: FREDERICK W. GIBB, III;Gibb Intellectual Property Law Firm, LLC, 844 West Street, SUITE 100, ANNAPOLIS, MD, 21401, US

(73) Assignee: International Business Machines Corporation, Armonk, NY (US)

(21) Appl. No.: 12/349,025

(22) Filed: Jan. 6, 2009

(51) Int. Cl. G06F 17/30

(52) U.S. Cl. 707/776; 707/E17.014; 707/E17.017

(57) ABSTRACT

A computer-implemented method that inputs a confirmed social network of a user, performs data mining of electronically accessible data for the user to produce a mined social network including individuals having a social relationship with the user and having an electronically accessible link to the user, subtracts the confirmed social network of the user from the mined social network to produce a recommendation list, in which the recommendation list includes at least one new individual not belonging to the confirmed social network of the use, and in which the recommendation list recommends the at least one new individual not belonging to the confirmed social network for membership in the confirmed social network, and outputs the recommendation list to the user.

### BACKGROUND

1. Field of the Invention

Exemplary embodiments of the invention generally relate to computer-implemented methods for recommending individuals to be invited into a confirmed social network of a user and, more particularly, to recommending individuals, who have a social relationship to the user, which is revealed by data mining to the user, into the confirmed social network of the user.

2. Description of the Related Art

Social networks, like Friendster®, MySpace®, Facebook®, LinkedIn® and others, require a user of the social network to specifically invite other users of the social network to connect to the user's confirmed social network, and for the invited other users to specifically confirm the connection in order to be added to the user's confirmed social network. Control of expanding the user's confirmed social network resides with the user and requires that the user encourage other users of the social network to connect to the user's confirmed social network. It is also possible to import connections from other social network applications into a confirmed social network. However, the increasing popularity of social networks has caused their memberships to increase by many tens, if not, hundreds of thousands of individuals. Thus, expanding the user's confirmed social network has become increasingly burdensome, because expansion requires that the user individually navigate to each one of the other users' profiles, among the thousands of profiles, to whom the user may extend an invitation to connect to his or her confirmed social network, read each one of the other user's profiles to which the user has navigated, optionally assess each one of the other user's profiles that the user has read, and if an invitation is to be extended, electronically link to and invite each one of the assessed other users to connect to the user's confirmed social network.

Enterprise social computing software, for example, the SOcial Networking ARchitecture (SONAR) by International Business Machines, Armonk, N.Y., USA, provides data mining of social data from documents, such as, blogs, wikis, and bookmarking systems, or email and instant messaging systems, to identify social networks, that is, to determine who interacts with whom. Other data mining programs data mine electronically accessible documents for social data in various public and private databases, for example, newspaper databases, publicly-accessible government databases, and corporate databases. Data mining is automatic and mined social data may include, for example, where an individual resides, how often a first individual emails a second individual, or that an individual recently purchased a home for a specified price.

Commonly, data mining for social data may also include ranking of the mined social data, for example, from strongest to weakest, in an ordered list for review by the user of the data mining program. For example, the data mining program may list individuals in decreasing order, based on the number of times an individual has emailed those individuals in a period of time.

There remains a need for a user of a confirmed social network to identify individuals, whom the user is likely invite to connect to his or her confirmed social network, without individually navigating to each one of a number of electronic links associated with an individual likely to be invited into the confirmed social network of the user, reading each of the documents pertaining to an individual, and sometimes assessing whether the individual should be invited to connect to the user's confirmed social network.

### SUMMARY

In view of the foregoing, an exemplary embodiment of the invention provides a computer-implemented method for performing data mining of electronically accessible data, including public and private online data, and locally maintained data, for example, e-mail, chats, tc., to identify individuals, who have a social relationship with the user of the social data mining program. The computer-implemented method inputs a previously existing confirmed social network of a first user that includes the first user and a plurality of second users, who have confirmed connections to the confirmed social network of the first user. Data mining produces a mined social network comprising at least one individual, who does not belong to the confirmed social network of the first user, yet who has a social relationship with the first user. The confirmed social network is a subset of the mined social network, where the mined social network includes members who have some type of social relationship with the first user, including belonging to the first user's confirmed social network and other types of social relationships. The mined social network, in turn, is a subset of the electronically accessible data mined by the social data mining program, for example, public and sometimes private databases and documents, and the Internet.

One feature of the embodiments herein is that the computer-implemented method subtracts the members of the previously confirmed social network of the first user from the newly mined social network. This automatically creates a recommendation list for the first user by subtracting the members of the confirmed social network from the individuals having an existing social relationship with the first user, and producing at least one new individual, who has a social relationship with the first user, but is not a member of the first user's confirmed social network Thus, the recommendation list comprises at least one new individual of the mined social network, who has a social relationship with the first user, but who is not already one of the plurality of second users of the previously confirmed social network of the first user. The recommendation list recommends the at least one new individual for membership in the confirmed social network of the first user. The computer-implemented method of the invention may then output the recommendation list to the first user.

The computer-implemented method of an exemplary embodiment of the invention further provides for calculating an aggregate weight comprising at least one weight based on a type of social relationship and an amount of evidence pertaining to the type of social relationship between the first user and a member of the recommendation list; and ordering the recommendation list according to the aggregate weight of each member of the recommendation list.

An exemplary embodiment of the invention provides the computer-implemented method, in which the outputting of the recommendation list comprises displaying the type of social relationship and the amount of evidence pertaining to the type of the social relationship between the first user and the member of the recommendation list.

The computer-implemented method of an exemplary embodiment of the invention further provides for monitoring the electronically accessible data for a new social relationship between the first user and new individuals not belonging to the confirmed social network of the first user; and dynamically updating the recommendation list to include the new individual having the new social relationship with the first user, when the mined social network reveals the new social relationship.

The computer-implemented method of an exemplary embodiment of the invention further provides for monitoring the mined social network for a new type of social relationship and for a new amount of evidence pertaining to an existing type of social relationship for each member of the recommendation list; and dynamically updating aggregate weights of the recommendation list when the mined social network reveals the new type of relationship or a new amount of evidence pertaining to an existing type of relationship of a member of the recommendation list.

Another exemplary embodiment of the invention provides a computer-implemented method in which, upon the first user reviewing the recommendation list, the computer-implemented method performs one of: (1) if the first user electronically links to and invites the at least one new individual into the confirmed social network of the first user and the at least one new individual confirms connection to the confirmed social network, then the method further comprises adding the at least one new individual to the confirmed social network and removing the at least one new individual from the recommendation list; and (2) if the first user does not electronically link to or invite the at least one new user into the confirmed social network, then either maintaining the at least one new individual on the recommendation list for subsequent review or removing the at least one new individual from the recommendation list.

Yet another exemplary embodiment of the invention provides a computer-implemented method that calculates an aggregate weight comprising at least one weight based on a type of social relationship and an amount of evidence pertaining to the type of social relationship between the first user and the member of the recommendation list, in which the type of social relationship includes at least one of common demographics of the first user and the member of the recommendation list, co-authorship of documents, commenting to each other on blogging systems, membership in the same organizations, common connections in other social networks, tagging in people tagging systems, co-bookmarking of the same documents, and common interests and others.

Yet another exemplary embodiment of the invention provides a computer program storage device readable by computer, tangibly embodying a program of instructions executable by the machine to perform the computer-implemented methods herein.

These and other aspects of exemplary embodiments of the invention will be better appreciated and understood when considered in conjunction with the following description and the accompanying drawings. It should be understood, however, that the following descriptions, while including a preferred embodiment of the invention and numerous specific details thereof, are given by way of illustration and not of limitation. Many changes and modifications may be made within the scope of exemplary embodiments of the invention without departing from the spirit thereof, and an exemplary embodiments of the invention include all such modifications.

### BRIEF DESCRIPTION OF THE DRAWINGS

Exemplary embodiments of the invention will be better understood from the following detailed description with reference to the drawings, in which:

FIG. 1 is a flow diagram illustrating a computer-implemented method for recommending new individuals to be invited into a confirmed social network of a user by data mining electronically accessible data for evidence of new social relationships between the user and the recommended new individuals in an exemplary embodiment of the invention; and

FIG. 2 is a Venn diagram illustrating the relationships between the first user of the confirmed social network, other members of the first user's confirmed social network, and at least one member of the mined social network, who does not belong to the first member's confirmed social network in an exemplary embodiment of the invention;

FIG. 3 is schematic block diagram illustrating a user interface displaying types of social relationships and evidence of the social relationships between the first user of the confirmed social network, who is performing data mining of social data, and a member of the recommendation list in an exemplary embodiment of the invention;

FIG. 4 is a schematic block diagram illustrating a hardware configuration of an information handling/computer system for recommending new individuals to be invited into a confirmed social network of a user by data mining electronically accessible data for evidence of new social relationships between the user and the recommended new individuals in an exemplary embodiment of the invention.

### DETAILED DESCRIPTION OF EMBODIMENTS

Exemplary embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure an exemplary embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

As stated above, there remains a need for a user of a confirmed social network to identify new individuals, whom the user is likely to invite to connect to his or her confirmed social network, without individually navigating to each one of the new individuals, reading a number of electronically accessible documents pertaining to the new individual, and sometimes assessing whether the new individual should be invited to connect to the user's confirmed social network, and if an invitation is to be extended, individually inviting each new individual to connect to the user's confirmed social network.

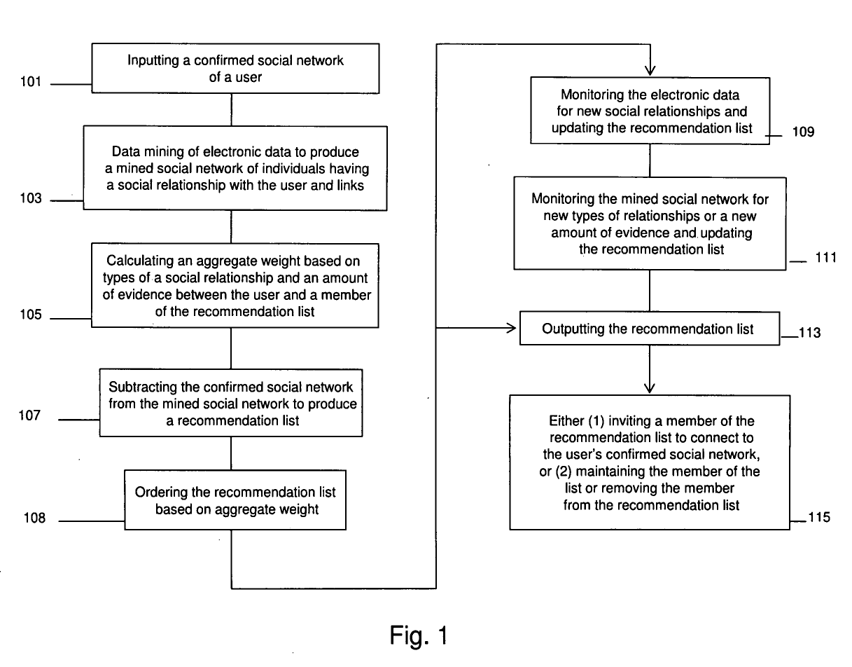

Exemplary embodiments of the invention achieve this by providing computer-implemented methods and a computer program storage device readable by a computer, that combine features of a user's confirmed social network and data mining of electronically accessible data, including public and private online data, and locally maintained data, for example, e-mail, chats, etc., for social data, to automatically provide a recommendation list of new individuals, having a social relationship with the user of the social data mining program, but not belonging to the user's confirmed social network, to be invited to connect to the user's confirmed social network. Referring now to the drawings, and more particularly to FIGS. 1 through 4, where reference items denote corresponding features throughout the figures, where are shown exemplary embodiments of the invention.

Referring to the flow diagram of FIG. 1, an exemplary embodiment of a computer-implemented method of the invention may input an existing confirmed social network of a first user, where the confirmed social network comprises the first user and a plurality of second users, as illustrated in item 101. The plurality of second users, having been previously invited to connect to the confirmed social network of the first user, has confirmed connections to the confirmed social network, as also illustrated in item 101 of the flow diagram of FIG. 1. That is, at some time in the past, each of the plurality of second users was invited by the first user to connect to his or her confirmed social network and then each invited user confirmed their connection to the first user's confirmed social network.

In an exemplary embodiment of the invention, the method may perform data mining for social data on the electronically accessible data, including the social network to which the first user's confirmed social network belongs, on repositories of co-authorship of publications or patents, commenting to each other on blogging systems, co-authorship of wikis, connections in other social networks, tagging each other in a people tagging system, co-bookmarking the same pages, etc., to identify individuals, who have a social relationship with the first user, as illustrated in item 103 of the flow diagram of FIG. 1. The plurality of second users of the first user's confirmed social network may be considered to have an existing social relationship with the first user, that is, the confirmed connection of the second user to the confirmed social network of the first user. The type of social relationships mined by the data mining program may, for example, be predetermined by the data mining program. Alternatively, the types of social relationships mined by the data mining program may be selected by the first user from a number of types of social relationships presented by the data mining program.

In an exemplary embodiment of the invention, the data mining for social data may further calculate an aggregate weight, based on one or more types of social relationships and an amount of evidence pertaining to the one of more types of social relationships between the first user and a member of the recommendation list, as illustrated in item 105 of the flow diagram of FIG. 1. For example, the data mining may have discovered that the first user and member “A” of the recommendation list have co-authored two patents. In an exemplary embodiment of the invention, a weight, based on a specific type of social relationship, for example, co-authoring a patent, and the amount of evidence for the specific type of social relationship, for example, co-authoring two patents, is assigned to each specific type of relationship for each member of the recommendation list. Additional weights may result from additional types of social relationships and amounts of evidence pertaining to these additional types of social relationships for member “A” of the recommendation list. These additional weights may be merged with the weight, corresponding to co-authoring two patents with the first user, to provide the aggregate weight for member “A” of the recommendation list.

At various times, for example, by initiation of the first user of the confirmed social network, periodically, or upon occurrence of a related event, such as, a new individual, having a social relationship to the first user and not yet belonging to the first user's confirmed social network, being identified by the social data mining program all the other members of the first user's confirmed social network, that is, the plurality of second users, may be subtracted from all the individuals having a social relationship with the first user, which constitute the mined social network, as illustrated in item 107 of the flow diagram of FIG. 1. In an exemplary embodiment of the invention, this subtraction process may identify at least one new individual, who has a social relationship with the first user, but who is not a member of the first user's confirmed social network. This at least one new individual may part of a recommendation list of new individuals to be invited and connected to the first user's confirmed social network, as also illustrated in item 107 of the flow diagram of FIG. 1. That is, the at least one new individual has a social relationship with the first user that is other than connection through the first user's existing confirmed social network.

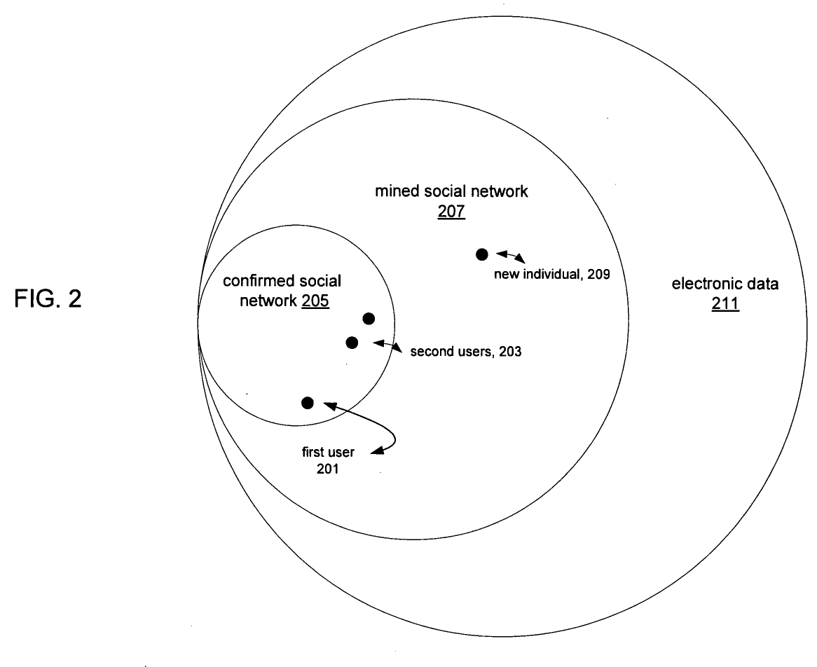

As shown by the Venn diagrams in FIG. 2, by subtracting the confirmed social network 205 of the first user, comprising the first user 201 and the existing plurality of second users 203, from the mined social network 207, an exemplary embodiment of the invention may automatically create a recommendation list for the first user that may comprise at least one new individual 209, who has a social relationship with the first user 201, but who is not a member of the first user's confirmed social network 205. The mined social network 207 comprises members who have various types of social relationships with the first user 201, including the plurality of second users 203, who have a confirmed connection to the confirmed social network 205 of the first user 201. The mined social network 207 is, in turn, a subset of the electronically accessible data 211, which may include members who do not have a social relationship with the first user 201, that is, do not belong to the mined social network 207. The recommendation list may recommend the at least one new individual 209, who has a social relationship with the first user 201, for membership in the confirmed social network 205 of the first user, as also illustrated in item 105 of the flow diagram of FIG. 1.

In an exemplary embodiment of the invention, various predetermined types of social relationships between the first user of the confirmed social network and the new individuals of the mined social network may include, but are not limited to, common demographics, co-authorship of documents or works of art, commenting to each other on blogging systems, membership in the same organizations, connections in other social networks, tagging in people tagging systems, co-bookmarking the same documents, and common interests. Alternatively, the first user may select various types of social relationships to be mined by the data mining program to produce the mined social network by, for example, selecting one or more types of social relationships provided by the data mining program.

In an exemplary embodiment of the invention, the recommendation list may further be ordered according to the aggregate weight of each member of the recommendation list, as shown in 108 of FIG. 1. Further, the recommendation list may be output to the first user for her or her review, as illustrated in item 113 of FIG. 1.

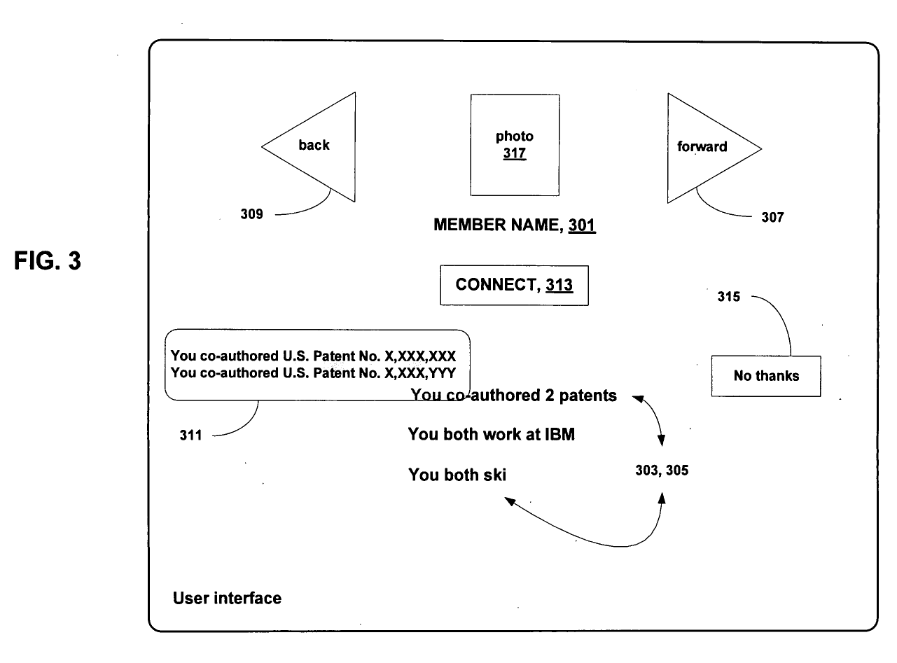

In an exemplary embodiment of the invention, the outputted recommendation list may be displayed to the first user on a user interface depicting, for example, information corresponding to a member of the recommendation list including, but not limited to, the member's name 301, the types of social relationship shared by the first user and the member of the recommendation list 303, and a brief description of the amount of evidence pertaining to the types of social relationships shared by the first user and the member of the recommendation list 305, as illustrated in FIG. 3. A user interface may also depict a photograph 317 of a member of the recommendation list along with the other information corresponding to the member.

In order to more clearly present information from the recommendation list to the first user, an exemplary embodiment of the invention may display but one member at a time of the recommendation list and the associated information of that one member on the user interface. In this case, the first user may traverse all members of the recommendation list by scrolling forward or back through the ordered recommendation list by selecting, for example, FORWARD or BACK widgets 307, 309 on the user interface, as also illustrated in FIG. 3. Furthermore, when the user selects a specific type of relationship section of the user interface, by, for example, “rolling over” the specific type of relationship section with his or her pointer, a “pop-up” or the like 311, may provide a more detailed presentation of the amount of evidence pertaining to the specific type of relationship, as also illustrated in FIG. 3.

The computer-related method of the invention may further monitor the electronically accessible data for new social relationships by, for example, further data mining over time, to identify a new social relationship between the first user and new individual not belonging to the confirmed social network of the first user, and may dynamically update the recommendation list to include the new individual having the new social relationship with the first user, when the mined social network reveals the new social relationship, as illustrated in item 109 of FIG. 1, in an exemplary embodiment of the invention.

The computer-related method of invention may also further monitor the mined social network for a new type of social relationship and for a new amount of evidence pertaining to an existing type of social relationship for each member of the recommendation list, and may dynamically update aggregate weights of the recommendation list when the mined social network reveals the new type of social relationship or a new amount of evidence pertaining to an existing type of social relationship of a member of the recommendation list, as illustrated in item 113 of FIG. 1, in an exemplary embodiment of the invention.

In an exemplary embodiment of the invention, upon the first user reviewing the outputted recommendation list, the computer-implemented method may perform one of: (1) if the first user electronically links to and invites the at least new individual into the confirmed social network of the first user and the at least one new individual confirms connection to the confirmed social network, then the method further comprises adding the at least one new individual to the confirmed social network and removing the at least one new individual from the recommendation list; and (2) if the first user does not electronically link to or invite the at least one new individual into the confirmed social network, then either maintaining the at least one new individual on the recommendation list for subsequent review or removing the at least one new individual from the recommendation list, as is shown in item 115 of the flow diagram of FIG. 1. Thus, the first user retains control of membership in his or her confirmed social network. The first user may electronically link to and invite the at least one new individual into the confirmed social network by selecting, for example, a CONNECT link or widget 313, in the user interface, as illustrated in FIG. 3. Alternatively, the first user may either decline inviting the new individual into the confirmed social network, saving the uninvited new individual for subsequent review, or remove the new individual from the recommendation list, by selecting, for example, a NO THANKS widget 315, in the user interface, as illustrated in FIG. 3.

The embodiments of the invention can take the form of an entirely hardware embodiment, an entirely software embodiment or an embodiment including both hardware and software elements. In a preferred embodiment, the invention is implemented in software, which includes but is not limited to firmware, resident software, microcode, etc.

Furthermore, the embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

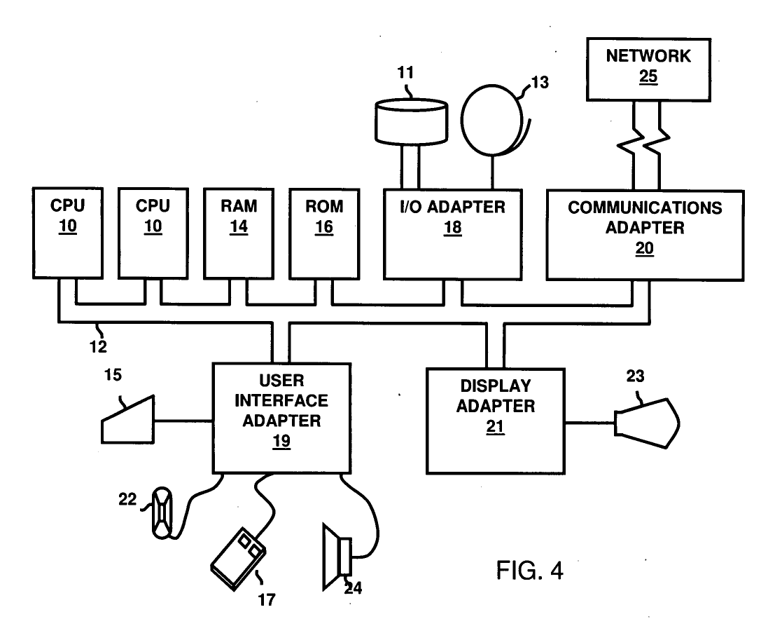

A representative hardware system and structure for practicing an exemplary embodiment of the invention is depicted in FIG. 4. This schematic drawing illustrates an exemplary hardware configuration of an information handling/computer system in accordance with an exemplary embodiment of the invention. This system may include at least one processor or central processing unit (CPU) 10. The CPUs 10 may be interconnected via a system bus 12 to various devices such as a random access memory (RAM) 14, read-only memory (ROM) 16, and an input/output (I/O) adapter 18. The I/O adapter 18 may connect to peripheral devices, such as disk units 11, tape drives 13, or other program storage devices that are readable by the system. The system may read the inventive instructions on the program storage devices and follow these instructions to execute the methodology of the invention. A user interface adapter 19 may connect a keyboard 15, mouse 17, speaker 24, microphone 22, and/or other user interface devices to the bus 12 to gather user input. In addition, a communication adapter 20 may connect the information handling system to a data processing network 25, and a display adapter 21 may connect the bus 12 to a graphical user interface (GUI) 23 or other similar output device.

It should be understood that the corresponding structures, materials, acts, and equivalents of all means or step plus function elements in the claims below are intended to include any structure, material, or act for performing the function in combination with other claimed elements as specifically claimed. Additionally, it should be understood that the above-description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated. Well-known components and processing techniques are omitted in the above-description so as to not unnecessarily obscure the embodiments of the invention.

Finally, it should also be understood that the terminology used in the above-description is for the purpose of describing particular embodiments only and is not intended to be limiting of the invention. For example, as used herein, the singular forms “a”, “an” and “the” are intended to include the plural forms as well, unless the context clearly indicates otherwise. Furthermore, as used herein, the terms “comprises”, “comprising,” and/or “incorporating” when used in this specification, specify the presence of stated features, integers, steps, operations, elements, and/or components, but do not preclude the presence or addition of one or more other features, integers, steps, operations, elements, components, and/or groups thereof.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of preferred embodiments, those skilled in the art will recognize that the embodiments of the invention can be practiced with modification within the spirit and scope of the appended claims.

What is claimed is:

1. A computer-implemented method, comprising:
inputting a confirmed social network of a first user, said confirmed social network comprising said first user and a plurality of second users, said plurality of second users having confirmed connections to said confirmed social network;
performing data mining of electronic accessible data, said data mining producing a mined social network comprising individuals having a social relationship with said first user and having an electronic link accessible to said first user;
subtracting said confirmed social network of said first user from said mined social network to produce a recommendation list, said recommendation list comprising at least one new individual not belonging to said confirmed social network, and said recommendation list recommending said at least one new individual for membership in said confirmed social network; and
outputting said recommendation list to said first user.

2. The computer-implemented method of claim 1, further comprising:
calculating an aggregate weight comprising at least one weight based on a type of social relationship and an amount of evidence pertaining to said type of social relationship between said first user and a member of said recommendation list; and
ordering said recommendation list according to said aggregate weight of each member of said recommendation list.

3. The computer-implemented method of claim 2, wherein said outputting of said recommendation list comprises displaying said type of social relationship and said amount of evidence pertaining to said type of social relationship, between said first user and said member of said recommendation list.

4. The computer-implemented method of claim 1, further comprising:
monitoring said electronically accessible data for a new social relationship between said first user and a new individual not belonging to said confirmed social network of said first user; and
dynamically updating said recommendation list to include said new individual having said new social relationship with said first user, when said mined social network reveals said new social relationship.

5. The computer-implemented method of claim 2, further comprising:
monitoring said mined social network for a new type of social relationship and for a new amount of evidence pertaining to an existing type of social relationship for each member of said recommendation list; and
dynamically updating aggregate weights of said recommendation list when said mined social network reveals said new type of relationship or a new amount of evidence pertaining to an existing type of relationship of a member of said recommendation list.

6. A computer-implemented method, comprising:
inputting a confirmed social network of a first user, said confirmed social network comprising said first user and a plurality of second users, said plurality of second users having confirmed connections to said confirmed social network;
performing data mining of electronically accessible data, said data mining producing a mined social network comprising individuals having a social relationship with said first user and having an electronic link accessible to said first user;
subtracting said confirmed social network of said first user from said mined social network to produce a recommendation list, said recommendation list comprising at least one new individual not belonging to said confirmed social network, and said recommendation list recommending said at least one new individual for membership in said confirmed social network;
outputting said recommendation list to said first user; and
upon said first user reviewing said recommendation list, said computer-implemented method further comprising one of:
if said first user electronically links to and invites said at least one new individual into said confirmed social network and said at least one new individual confirms connection to said confirmed social network, then said method further comprises adding said at least one new individual to said confirmed social network and removing said at least one new individual from said recommendation list; and
if said first user does not electronically link to or invite said at least one new individual into said confirmed social network, then said method further comprises either maintaining said at least one new individual on said recommendation list for subsequent review or removing said at least one new individual from said recommendation list.

7. The computer-implemented method of claim 6, further comprising:
calculating an aggregate weight comprising at least one weight based on a type of social relationship and an amount of evidence pertaining to said type of social relationship between said first user and a member of said recommendation list; and
ordering said recommendation list according to said aggregate weight of each member of said recommendation list.

8. The computer-implemented method of claim 7, wherein said outputting of said recommendation list comprises displaying said type of social relationship and said amount of evidence pertaining to said type of social relationship, between said first user and said member of said recommendation list.

9. The computer-implemented method of claim 6, further comprising:
monitoring said electronically accessible data for a new social relationship between said first user and a new individual not belonging to said confirmed social network of said first user; and
dynamically updating said recommendation list to include said new individual having said new social relationship with said first user, when said mined social network reveals said new social relationship.

10. The computer-implemented method of claim 7, further comprising:
monitoring said mined social network for a new type of social relationship and for a new amount of evidence pertaining to an existing type of social relationship for each member of said recommendation list; and
dynamically updating aggregate weights of said recommendation list when said mined social network reveals said new type of relationship or a new amount of evidence pertaining to an existing type of relationship of a member of said recommendation list.

11. A computer-implemented method, comprising:
inputting a confirmed social network of a first user, said confirmed social network comprising said first user and a plurality of second users, said plurality of second users having confirmed connections to said confirmed social network;
performing data mining of electronically accessible data, said data mining producing a mined social network comprising individuals having a social relationship with said first user and having an electronic link accessible to said first user;
calculating an aggregate weight comprising at least one weight based on a type of social relationship and an amount of evidence pertaining to said type of social relationship between said first user and a member of said mined social network,
wherein said type of social relationship includes at least one of common demographics of said first user and said member of said recommendation list, co-authorship of documents, commenting to each other on blogging systems, membership in the same organizations, common connections in other social networks, tagging in people tagging systems, co-bookmarking of the same documents, and common interests, and
wherein a weight of a specific type of social relationship and an amount of evidence, pertaining to said specific type of social relationship, comprises a predetermined value, based on said specific type of social relationship and said amount of evidence pertaining to said specific type of social relationship;
subtracting said confirmed social network of said first user from said mined social network to produce a recommendation list, said recommendation list comprising at least one new individual not belonging to said confirmed social network, and said recommendation list recommending said at least one new individual for membership in said confirmed social network;
ordering said recommendation list according to said aggregate weight of each member of said recommendation list; and
outputting said recommendation list to said first user.

12. The computer-implemented method of claim 11, further comprising:
monitoring said electronically accessible data for a new social relationship between said first user and a new individual not belonging to said confirmed social network of said first user; and
dynamically updating said recommendation list to include said new individual having said new social relationship with said first user, when said mined social network reveals said new social relationship.

13. The computer-implemented method of claim 11, further comprising:
monitoring said mined social network for a new type of social relationship and for a new amount of evidence pertaining to an existing type of social relationship for each member of said recommendation list; and
dynamically updating aggregate weights of said recommendation list when said mined social network reveals said new type of relationship or a new amount of evidence pertaining to an existing type of relationship of a member of said recommendation list.

14. The computer-implemented method of claim 11, wherein upon said first user reviewing said recommendation list, said computer-implemented method further comprises one of:
if said first user electronically links to and invites said at least one new individual into said confirmed social network and said at least one new individual confirms connection to said confirmed social network, then adding said at least one new individual to said confirmed social network and removing said at least one new individual from said recommendation list; and
if said first user does not electronically link to or invite said at least one new individual into said confirmed social network, then either maintaining said at least one new individual on said recommendation list for subsequent review or removing said at least one new individual from said recommendation list.

15. A computer program storage device readable by computer, tangibly embodying a program of instructions executable by said machine to perform a computer-implemented method comprising:
inputting a confirmed social network of a first user, said confirmed social network comprising said first user and a plurality of second users, said plurality of second users having confirmed connections to said confirmed social network;
performing data mining of electronically accessible data, said data mining producing a mined social network comprising individuals having a social relationship with said first user and having an electronic link accessible to said first user;
subtracting said confirmed social network of said first user from said mined social network to produce a recommendation list, said recommendation list comprising at least one new individual not belonging to said confirmed social network, and said recommendation list recommending said at least one new individual for membership in said confirmed social network; and
outputting said recommendation list to said first user.

16. The computer program storage device of claim 15, said computer-implemented method further comprising:
calculating an aggregate weight comprising at least one weight based on a type of social relationship and an amount of evidence pertaining to said type of social relationship between said first user and a member of said recommendation list; and
ordering said recommendation list according to said aggregate weight of each member of said recommendation list.

17. The computer program storage device of claim 16, wherein said outputting of said recommendation list comprises displaying said type of social relationship and said amount of evidence pertaining to said type of social relationship, between said first user and said member of said recommendation list.

18. The computer program storage device of claim 15, said computer-implemented method further comprising:
monitoring said electronically accessible data for a new social relationship between said first user and a new individual not belonging to said confirmed social network of said first user; and
dynamically updating said recommendation list to include said new individual having said new social relationship with said first user, when said mined social network reveals said new social relationship.

19. The computer program storage device of claim 16, said computer-implemented method further comprising:
monitoring said mined social network for a new type of social relationship and for a new amount of evidence pertaining to an existing type of social relationship for each member of said recommendation list; and
dynamically updating aggregate weights of said recommendation list when said mined social network reveals said new type of relationship or a new amount of evidence pertaining to an existing type of relationship of a member of said recommendation list.

20. The computer program storage device of claim 15, wherein upon said first user reviewing said recommendation list, said computer-implemented method further comprises one of:
if said first user electronically links to and invites said at least one new individual into said confirmed social network and said at least new individual confirms connection to said confirmed social network, then said method further comprises adding said at least one new individual to said confirmed social network and removing said at least one new individual from said recommendation list; and
if said first user does not electronically link to or invite said at least one new individual into said confirmed social network, then either maintaining said at least one new individual on said recommendation list for subsequent review or removing said at least one new individual from said recommendation list.
